(19) United States
(12) Patent Application Publication
(10) Pub. No.: US 2005/0184429 A1
(43) Pub. Date: Aug. 25, 2005

(54) Method and apparatus for melt spinning and cooling a plurality of synthetic filaments

(75) Inventor: Horst Kropat, Neumunster (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Saurer GmbH & Co. KG

(21) Appl. No.: 11/115,005

(22) Filed: Apr. 26, 2005

Related U.S. Application Data
(63) Continuation of application No. PCT/EP03/11807, filed on Oct. 24, 2003.

(30) Foreign Application Priority Data
Nov. 9, 2002 (DE) 102 52 169.7

(51) Int. Cl. B29C 47/78

(52) U.S. Cl. 264/211.24; 425/72.2

(57) ABSTRACT

A method and an apparatus for melt spinning and cooling a plurality of synthetic filaments, wherein the filaments are extruded in a first step in an annular arrangement by means of a spinneret (1). The filaments subsequently advance along an outflow quench diffuser (12) and undergo cooling by an airflow that radially emerges from the jacket of the outflow quench diffuser. The filaments undergo for purposes of being solidified and before being cooled by the diffuser jacket airflow, a precooling by an additional precooling airflow (7), which is generated by a cooling means (6) arranged between the spinneret (1) and the outflow quench diffuser (12).

### CROSS REFERENCE TO RELATED APPLICATION

The present application is a continuation of international application PCT/EP2003/011807, filed 24 Oct., 2003, and which designates the U.S. The disclosure of the referenced application is incorporated herein by reference.

### BACKGROUND OF THE INVENTION

The present invention relates to a method and apparatus for melt spinning and cooling a plurality of synthetic filaments to form a multifilament yarn, of the general type disclosed, for example, in DE 36 29 731 A1.

In the production of staple fibers, the fibers are extruded in a first step as strandlike filaments from a polymer melt by means of a spinneret with a plurality of spin holes. Depending on the throughputs of the spin holes and the withdrawal speeds from the spinneret, one distinguishes between so-called short spinning processes and long spinning processes. In the case of short spinning processes, low withdrawal speeds and low spin hole throughputs are adjusted, so that a cooling of the freshly extruded filament strands is possible within a short distance. In such processes, however, one uses spinnerets which have a very large number of spin holes, so that a relatively dense sheet of filaments is produced and must be cooled. To this end, one employs, for example, cooling devices as are disclosed in U.S. Pat. No. 5,178,814. In these devices a cooling air stream is generated downstream of the spinneret, which is operative over a very short length and radially penetrates the filament sheet from the inside outward.

In the so-called long spinning processes, however, one obtains a very much higher throughput through the spinneret and accordingly substantially higher withdrawal speeds. To cool the freshly extruded filaments in an optimal manner, a long and uniform quench zone is needed. To this end, so-called outflow quench diffusers have been found to be particularly effective, which form a radially emerging airflow over a uniform quench zone on their jacket. A method as well as an apparatus of this type are disclosed in DE 36 29 731 A1, which forms the basis of the invention.

By the known method and the known apparatus, the filaments are extruded through annularly arranged spin holes in the spinneret. Arranged downstream of the spinneret is the outflow quench diffuser. The outflow quench diffuser has a porous jacket, which consists, for example, of a sintered material, so that the cooling air having entered the interior of the outflow quench diffuser via an air supply system radially emerges from the jacket of the outflow quench diffuser and cools as a diffuser jacket airflow the filament strands as they advance along the outflow quench diffuser. In the known apparatus, the outflow quench diffuser has at its free end a closable annular gap, which is opened for pivoting and moving the diffuser, so that the filament strands are prevented from gluing to the outflow quench diffuser while it is being moved to an operating position. As soon as the outflow quench diffuser has reached its operating position downstream of the spinneret, the annular gap will be closed. The filaments are exclusively cooled by the airflow from the diffuser jacket.

In the known method and known apparatus, one has found in particular when melt spinning and cooling filaments with fine deniers, that outer lying filaments are often subjected to breaks. Since the use of the spin holes in the spinneret and thus that of the extruded filaments is greater in the case of fine deniers than in the case of coarse deniers, the airflow from the jacket of the outflow quench diffuser performs an inadequate cooling of all filaments.

Likewise, the adjustment of an airflow profile on the diffuser, such as is disclosed in DE 37 08 168 A1, has been unable to solve the problem.

It is therefore an object of the invention to further develop a method and an apparatus of the initially described type such that they permit a uniform cooling of a plurality of extruded filaments with relatively fine deniers, which advance in an annular arrangement.

### SUMMARY OF THE INVENTION

The invention has the advantage that cooling of the filament starts already directly after the filaments emerge from the spinneret. To this end, an additional cooling means generates between the spinneret and the outflow quench diffuser a precooling airflow that is directed toward the filaments for precooling. This results in a greater flexibility in the cooling of the filaments. In particular in the production of staple fibers, the intensive precooling of the filaments showed a possibility of producing especially fine deniers.

It was also possible to improve the effect in that the method of the invention causes the precooling airflow and the diffuser jacket airflow to impact upon the filaments in the same direction, with the velocity of the precooling airflow being higher than the velocity of the diffuser jacket airflow. With that, it was possible to realize on the one hand a uniform spreading of the filament sheet. On the other hand, the intensive precooling airflow led to a uniform and thorough precooling of all filaments within the filament sheet. The subsequent further cooling of the filaments by the diffuser jacket airflow along the diffuser permits in particular a uniform solidification of the filaments even at higher withdrawal speeds.

To obtain a uniform and intensive penetration of the filament sheet for evenly cooling also the filaments advancing in the outer region, an adjustment has turned out to be favorable, wherein the velocity of the precooling airflow upon its emergence is at least twice as high as the velocity of the diffuser jacket airflow, when it emerges.

In this connection, a precooling airflow generated in particular by a ring slot nozzle has shown to be most effective. To this end, the ring slot nozzle comprises an annular nozzle opening arranged in spaced relationship with the filaments. With that, it was possible to achieve in particular a total displacement of the warm air that is entrained in the filament sheet, which improved in particular the further cooling of the filaments by the diffuser jacket air flow.

To ensure that both the precooling and the further cooling of the filaments can occur with optimized airflows, an advantageous further development provides for adjusting the precooling airflow independently of the diffuser jacket airflow.

To carry out the method, the apparatus of the invention includes an additional cooling means between the spinneret and the outflow quench diffuser, which is used to generate an additional precooling airflow for precooling the filaments.

In this connection, the additional cooling means and the outflow quench diffuser may be jointly connected to an air supply device or be each supplied by separate air supply devices. To obtain a precooling airflow operating at a possibly higher velocity than the diffuser jacket airflow, the cooling means is preferably constructed as a ring slot nozzle, from which the precooling airflow emerges through a nozzle opening that is annularly arranged in spaced relationship with the filaments.

In this process, it is possible to realize an intensive precooling of the extruded filaments in particular in that the spacing between the nozzle opening of the ring slot nozzle and the filaments is kept smaller than the spacing between the jacket of the outflow quench diffuser and the filaments.

Furthermore, it is possible to influence the flow velocity of the precooling air in that the nozzle opening is adjustable in its clearance height.

The additional cooling means may be rigidly connected directly downstream of the spinneret or directly to the outflow quench diffuser.

### BRIEF DESCRIPTION OF THE DRAWINGS

In the following, the method of the invention is described in greater detail by means of several embodiments of the apparatus according to the invention with reference to attached drawings, in which:

FIG. 1 is a schematic cross sectional view of a first embodiment of an apparatus which embodies the present invention;

FIG. 2 is a schematic cross sectional view of a further embodiment of an apparatus according to the invention; and

FIGS. 3 and 4 are schematic cross sectional views of further embodiments of an apparatus according to the invention.

### DETAILED DESCRIPTION OF THE PREFERRED EMBODIMENTS

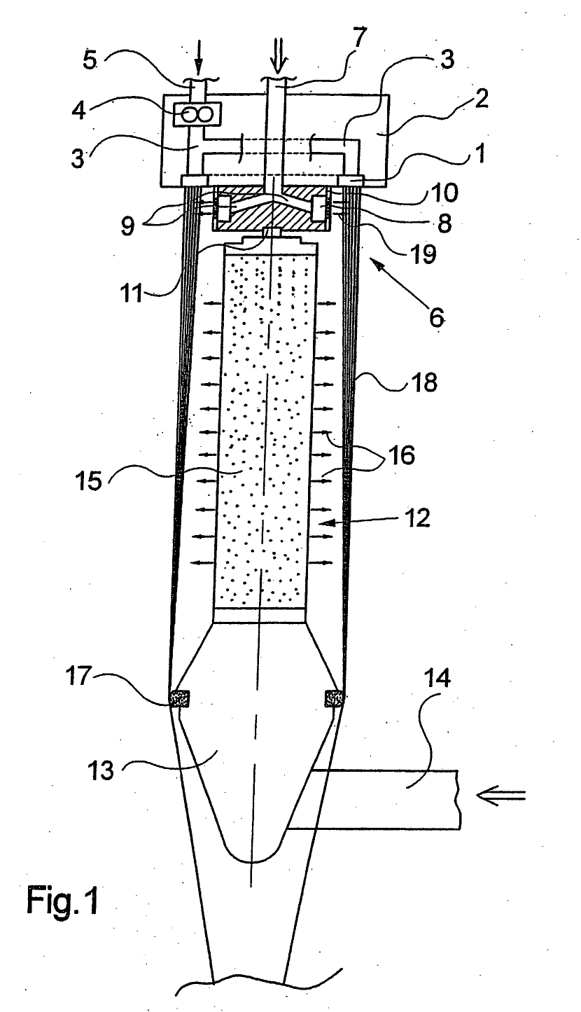

FIG. 1 schematically illustrates a cross sectional view of a first embodiment of the apparatus according to the invention. The apparatus comprises a spinneret 1, which is arranged inside a heated spin beam 2. The spinneret 1 is made annular, preferably circular or rectangular, and arranged on the underside of the spin beam 2. The spinneret 1 connects via melt distribution lines 3 to a spin pump 4. The spin pump 4 receives a polymer melt, for example, from an extruder via a melt supply line 5. On its underside, the spinneret 1 comprises a plurality of spin holes (not shown), from each of which a filament is extruded in the form of a strand.

Arranged on the underside of the spin beam 2 is a cooling means in the form of an outflow quench system 6. To this end, the outflow quench system 6 includes an annular air chamber 8 and an air-permeable wall 10 covering the air chamber 8 toward the outside. In its size, the quench system 6 is dimensioned such that there is a space between a sheet of filaments 18 extruded from the spinneret 1 and the air-permeable wall 10. The quench system 6 connects to a first air supply 7, which extends through the spin beam 2 and the spinneret 1. The air supply 7 connects via air distribution lines 9 to the air chamber 8.

Arranged downstream of the quench system 6 and within the annular arrangement of downwardly advancing filaments is an outflow quench diffuser 12, which lies at its upper end via a centering stop 11 against the quench system 6. At its opposite end, the outflow quench diffuser 12 connects to a mounting device 13. The outflow quench diffuser 12 comprises a porous jacket 15, which may be made, for example, from a nonwoven material, foam, screen mesh, or a sintered material. The mounting device 13 connects to a second air supply 14, with the interior of the outflow quench diffuser 12 communicating with the air supply 14 via the mounting device 13. Preferably, the mounting device 13 is made movable for guiding it out of or into the threadline for servicing, or cleaning, or changing the outflow quench diffuser 12.

Downstream of the outflow quench diffuser 12, the mounting device 13 comprises a yarn lubrication ring 17, which is contacted by the sheet of filaments 18 for applying a lubricant to the filaments.

With the use of the apparatus shown in FIG. 1, the spin pump 4 delivers in operation a polymer melt under pressure to the spinneret 1. In this process, strandlike filaments emerge on the underside from the spin holes of the spinneret 1, which form the sheet of filaments 18. The sheet of filaments 18 is annularly advanced and jointly withdrawn from the spinneret 1 by a withdrawal mechanism (not shown).

At a short distance downstream of the spinneret 1, the cooling means that is constructed as an air quench system 6, directs a precooling airflow 19 from the inside radially outward through the sheet of filaments 18. The intensity of the precooling airflow 19 can be directly regulated via the air supply 7. The precooling airflow 19 is adjusted such that each of the filaments advancing within the sheet undergoes a uniform cooling. In addition, the filament sheet is spread, so that the individual filaments in the filament sheet can be uniformly surrounded by the subsequent airflow from the diffuser jacket.

For their solidification, the filaments undergo a further cooling by an airflow 16 from the jacket of the outflow quench diffuser 12. With that, a uniform and adequate cooling of the filaments is also realized at high spinning speeds of more than 800 m/min. To obtain an intensive and uniform precooling of the filaments, the velocity of the precooling airflow is set higher than the velocity of the diffuser jacket airflow. To this end, the spacing between the air-permeable wall 10 and the sheet of filaments 18 is adjusted substantially smaller than the spacing between the diffuser jacket 15 and the sheet of filaments 18.

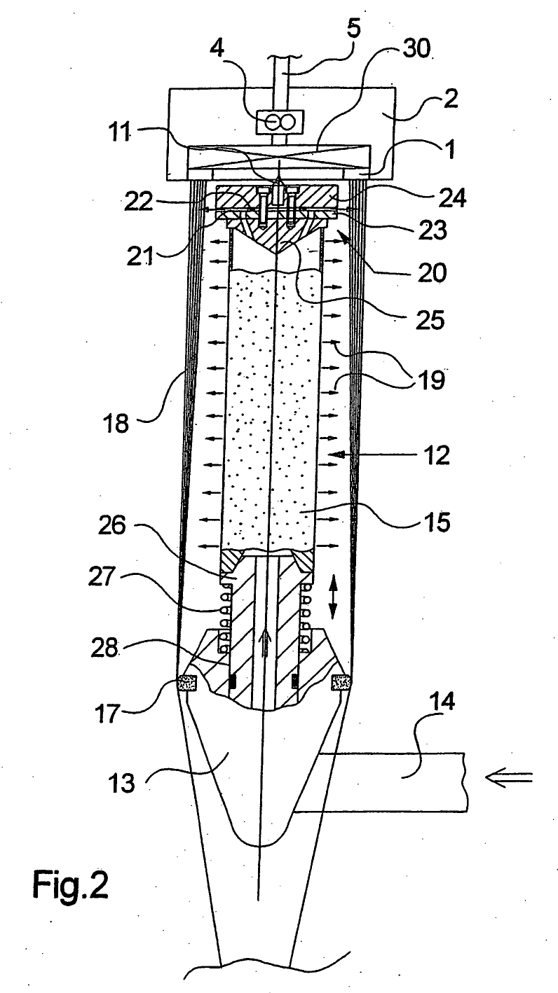

FIG. 2 illustrates a second embodiment of an apparatus configured to carry out the method of the invention. In this embodiment, the precooling airflow is generated by a cooling means that is constructed as a ring slot nozzle 20. The precooling airflow emerging from a nozzle opening 21 produces a relatively strong quench flow for effecting a precooling in the sheet of filaments. In the following description of the embodiment with reference to FIG. 2, components of like function are indicated at identical numerals. In the embodiment of the apparatus according to the invention as shown in FIG. 2, an annular spinneret 1 connects via a melt distributor 30 to a spin pump 4. The spin pump 4, melt distributor 30, and spinneret 1 are arranged in a heated spin beam 2.

Arranged downstream of the spinneret 1 is an additional cooling means in the form of the ring slot nozzle 20. The ring slot nozzle 20 is rigidly connected to the outflow quench diffuser 12. To this end, the outflow quench diffuser 12 comprises at its free end a head plate 25. The ring slot nozzle 20 is constructed in the shape of a collar at the free end of the outflow quench diffuser 12 and rigidly connected to the head plate 25. The circumferentially annular nozzle opening 21 of the ring slot nozzle 20 is formed between a perforated plate 23 and a cover plate 24, which are secured to each other via a sealing ring 22. The clearance height of the nozzle opening 21 is determined by the thickness of the sealing ring 22. With that, it is possible to adjust any desired clearance height of the opening 21 of ring slot nozzle 20 by exchanging or varying the sealing ring 22. The nozzle opening 21 connects via passageways in the perforated plate 23 and head plate 25 to the interior of the outflow quench diffuser 12. Thus, the ring slot nozzle 20 and the outflow quench diffuser 12 are supplied via a common air supply 14. The ring slot nozzle 20 and the outflow quench diffuser 12 are secured by means of a mounting device 13 with a centering stop 11 to the underside of the spin beam 2.

The outflow quench diffuser 12 of FIG. 2 is constructed for axial displacement relative to the mounting device 13, with axially operative biasing means 27 holding the outflow quench diffuser 12 in an operating position. An axially displaceable outflow quench diffuser of this type is disclosed in EP 1 231 302 A1, so that this prior art publication is herewith incorporated by reference. In this arrangement, the outflow quench diffuser 12 is held at its lower end in a connecting element 26, which extends for displacement in a centering opening 28 of the mounting device 13. In the present embodiment, the biasing means 27 is a compression spring, which facilitates an axial displacement of the outflow quench diffuser for exchanging it.

The further construction of the apparatus of FIG. 2 is identical with that of the apparatus of FIG. 1, so that the foregoing embodiment is herewith incorporated by reference.

For cooling the filaments, the outflow quench diffuser 12 receives a cooling airflow via the air supply 14 and mounting device 13. In this process, a portion of the cooling airflow enters the ring slot nozzle 20 directly at the free end via passageways in the head plate 25. A relatively strong precooling airflow then emerges from the nozzle opening 21 at a short distance from the sheet of filaments 18 and penetrates the sheet of filaments 18. At the same time, a radially directed airflow emerges from the porous jacket 15 of the outflow quench diffuser 12.

In tests, it was found that with the use of a common air supply, the precooling airflow had an exit velocity of about 10 m/sec., whereas the exit velocity of the diffuser jacket airflow was about 3 m/sec. This made it possible to produce stable fibers, which had a final denier of 0.6 dtex. With a standard design of the outflow quench diffuser without additional cooling means and under the same air supply conditions, it was possible to produce only fibers with a final denier of more than 0.9 dtex. It was not possible to reliably produce finer deniers because of frequently occurring filament breaks. Only with the method of the invention was it possible to accomplish that fibers of fine deniers can be reliably produced without occurrence of filament breaks. It was also possible to further optimize precooling of the filaments by varying the clearance height of the nozzle opening 21 of ring slot nozzle 20. In this instance, the clearance height ranged from 0.1 to 0.9 mm.

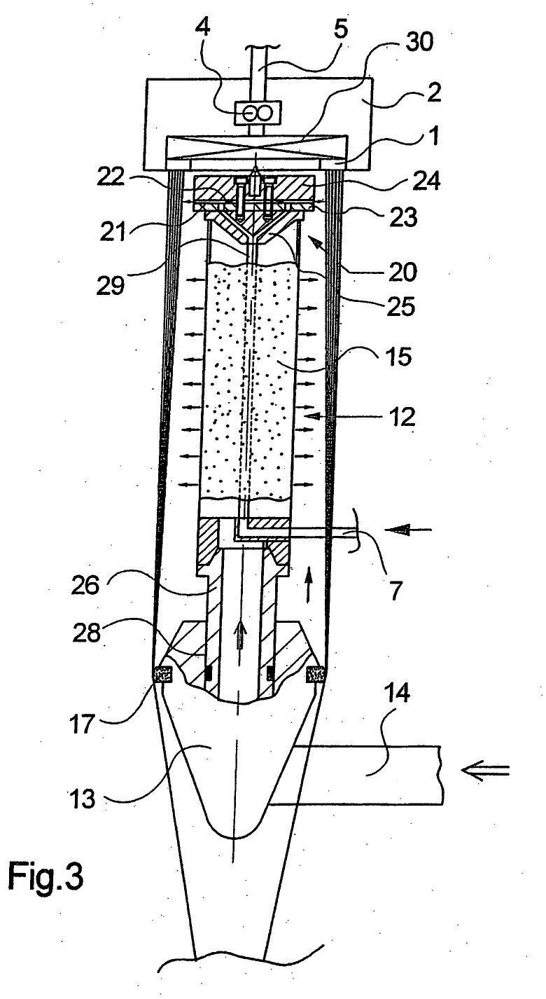

FIG. 3 illustrates a further embodiment of an apparatus according to the invention for carrying out the method of the invention. The embodiment of FIG. 3 is largely identical with the foregoing embodiment of FIG. 2. In this respect, the foregoing description is herewith incorporated by reference and only differences will be pointed out.

In the embodiment illustrated in FIG. 3, the additional cooling means is likewise constructed as a ring slot nozzle 20 that extends at the free end of the outflow quench diffuser 12 in the shape of a collar. The construction of the ring slot nozzle 20 is identical with the embodiment of FIG. 2.

Inside the outflow quench diffuser 12, an air supply line 29 extends, which connects with its one end to the passageways in the head plate 25. With its other end, the air supply line 29 connects to the air supply 7. Thus, the ring slot nozzle 20 can be separately supplied with a cooling airflow independently of the cooling air supply to the outflow quench diffuser 12. The outflow quench diffuser 12 connects to the air supply 14 via the mounting device 13. With that, it is possible to adjust the precooling airflow and the diffuser jacket airflow independently of each other for cooling the filaments. In addition, it would also be possible to use different cooling media or different compositions of the cooling air for causing the filaments to solidify.

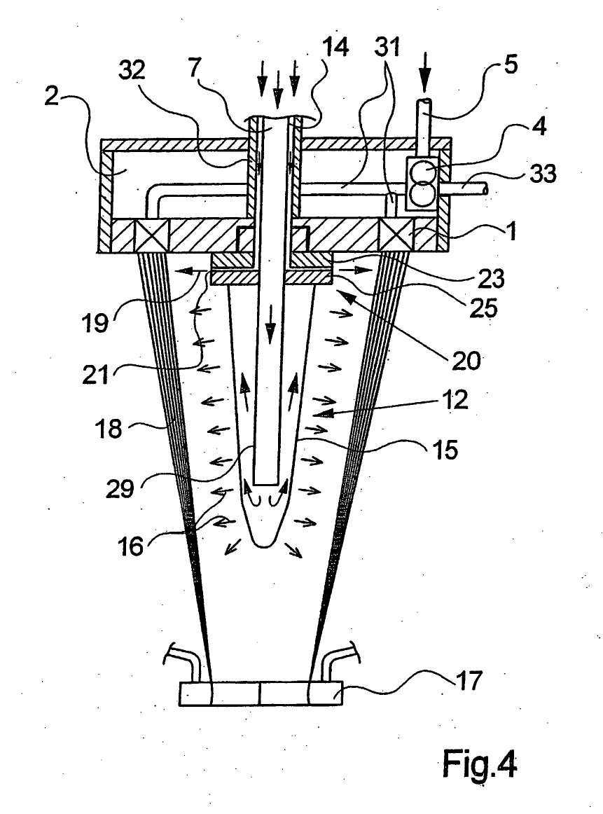

A further embodiment of the apparatus according to the invention is schematically illustrated in FIG. 4. The embodiment differs essentially in that an outflow quench diffuser 12 is mounted to the underside of a spin beam 2, as is disclosed, for example, in EP 1 247 883 A1. As regards the construction and operation of an apparatus of this type, the contents of the cited publication are herewith expressly incorporated by reference. In the following description of the embodiment with reference to FIG. 4, components of like function are provided with the same numerals as in the foregoing embodiments.

In the embodiment of the apparatus according to the invention as shown in FIG. 4, an annular spinneret 1 connects via melt distribution lines 31 to a spin pump 4. The spin pump 4 is driven by a drive shaft 33. The spin pump 4, distribution lines 31, and spinneret 1 are arranged in a heated spin beam 2. Arranged downstream of the spinneret 1 is a ring slot nozzle 20 as an additional cooling means. On its underside, the ring slot nozzle 20 is rigidly connected to an outflow quench diffuser 12. The ring slot nozzle 20 and the outflow quench diffuser 12 connect with their end facing the spin beam 2 to an air supply system. A first air supply 7 is formed by an inner air supply line 29, which extends through the spin beam 2 and projects into the outflow quench diffuser 12. The inner air supply line 29 is enclosed by an outer air supply line 32, which connects to the ring slot nozzle 20, and is used to provide a second air supply 14 to the ring slot nozzle 20.

The ring slot nozzle 20 is formed by a perforated plate 23 and by a head plate 25 arranged below the perforated plate. The perforated plate 23 comprises an inlet, which is connected to the nozzle opening 21 between the perforated plate 23 and the head plate 25. Subjacent to the head plate 25 is the outflow quench diffuser 12.

Downstream of the outflow quench diffuser 12 is a lubrication device in the form of lubrication ring 17, which surrounds a sheet of filaments 18 that is extruded through the spinneret 1. The sheet of filaments 18 advances along an inner contact surface of the lubrication ring 17.

In the embodiment shown in FIG. 4, the filaments of the sheet of filaments 18 that have been freshly extruded by the spinneret 1 are initially cooled after emerging from the spinneret 1 by a precooling airflow 19, which is generated by the ring slot nozzle 20. After an intensive precooling, the sheet of filaments 18 undergoes a further cooling by the diffuser jacket airflow 16, which is generated by the jacket 15 of the outflow quench diffuser 12. As has been previously described, the clearance height of the opening 21 of ring slot nozzle 20 can be varied to be able to adjust the intensity of the precooling of the sheet of filaments 18 to defined conditions.

The apparatus illustrated in the embodiments of FIGS. 1-4 are exemplary in their construction and can be selectively combined. Thus, for example, it would be possible to arrange a cooling means in the form of a ring slot nozzle directly downstream of the spin beam as shown in FIG. 1. However, it is also possible to construct the cooling means with a plurality of annular nozzle openings, which are successively arranged at short distances from one another. Important for the invention is that it makes it possible to generate at a short distance downstream of the spinneret an intensive precooling airflow for precooling the filaments, and that a longer lasting, further cooling of the filaments follows by means of an outflow quench diffuser.

1. A method for melt spinning and cooling a plurality of filaments, comprising the steps of
extruding an annular arrangement of a plurality of downwardly advancing filaments so that the filaments advance in spaced relationship with an outflow quench diffuser which has a peripheral jacket,
cooling the filaments by subjecting the filaments to an airflow that radially emerges from the jacket of the outflow quench diffuser, and
before the cooling step, precooling the advancing filaments by an additional precooling inflow.

2. The method of claim 1, wherein the precooling airflow and the diffuser jacket airflow impact upon the filaments in the same direction, with the flow velocity of the precooling airflow being higher than the flow velocity of the diffuser jacket airflow.

3. The method of claim 2, wherein the flow velocity of the precooling airflow is at least twice as high as the diffuser jacket airflow.

4. The method of claim 1, wherein the precooling airflow is generated by a ring slot nozzle, which comprises an annular nozzle opening arranged in spaced relationship with the filaments.

5. The method of claim 1, wherein the precooling airflow and the diffuser jacket airflow are adjustable independently of each other.

6. An apparatus for melt spinning and cooling a plurality of filaments, comprising
a spinneret for receiving a melt and extruding an annular arrangement of a plurality of downwardly advancing filaments,
an outflow quench diffuser arranged downstream of the spinneret and within the annular arrangement of filaments for generating a radial airflow which emerges from a peripheral jacket for cooling the filaments, and
an additional cooling means positioned between the spinneret and the outflow quench diffuser for generating an additional airflow for precooling the filaments.

7. The apparatus of claim 6, wherein the additional cooling means and the outflow quench diffuser connect to a common air supply.

8. The apparatus of claim 6, wherein the additional cooling means and the outflow quench diffuser connect to independently controllable air supplies.

9. The apparatus of claim 6, wherein the additional cooling means comprises a ring slot nozzle, which comprises an annular nozzle opening arranged in spaced relationship with the filaments.

10. The apparatus of claim 9, wherein the spacing between the nozzle opening of the ring slot nozzle and the filaments is substantially smaller than the spacing between the jacket of the outflow quench diffuser and the filaments.

11. The apparatus of claim 9 wherein the nozzle opening of the ring slot nozzle has a variable clearance height.

12. The apparatus of claim 6, wherein the additional cooling means is rigidly connected to the outflow quench diffuser.

13. The apparatus of claim 12, wherein the additional cooling means comprises a ring slot nozzle, and wherein the ring slot nozzle is formed in a circumferential collar that is positioned above the outflow quench diffuser.

14. The apparatus of claim 6, wherein the lower end of the outflow quench diffuser is connected to a mounting device which is positioned within the annular arrangement of filaments and which is configured to receive an air supply which is then delivered to the interior of the outflow quench diffuser.

15. The apparatus of claim 14, wherein the outflow quench diffuser is secured to the mounting device such that the outflow quench diffuser is axially adjustable relative to the mounting device between an operating position and a standby position, and that the outflow quench diffuser is clamped in the operating position between the mounting device and the additional cooling means or the spinneret.
